(19) United States
(12) Patent Application Publication
(10) Pub. No.: US 2011/0117941 A1
(43) Pub. Date: May 19, 2011

(54) INFORMATION SHARING DURING CALLING

(75) Inventor: Bo Zhang, Beijing (CN)

(73) Assignee: SONY ERICSSON MOBILE COMMUNICATIONS AB, Lund (SE)

(21) Appl. No.: 13/003,620

(22) PCT Filed: Aug. 14, 2009
(86) PCT No.: PCT/CN09/01006

§ 371 Date: Jan. 11, 2011

(30) Foreign Application Priority Data
Aug. 14, 2008 (CN) 20810129871.8

(51) Int. Cl. H04W 4/00

(52) U.S. Cl. 455/466

(57) ABSTRACT

The present invention relates to information sharing during calling, and specifically discloses a method of sharing information between two calling parties in a wireless communication system, characterized in that the first calling party uses information sharing function activated in a first mobile communication terminal of the first calling party during calling, and automatically takes a second mobile communication terminal of the second calling party as the called party as destination to transmit information in the first mobile communication terminal for sharing.

### FIELD OF THE INVENTION

The present invention relates to information sharing during calling, and more particularly to information sharing between mobile communication terminals during calling.

### DESCRIPTION OF THE RELATED ARTS

It often comes upon such circumstances that when a first party telephones a second party to ask for the telephone number of a third party or such other information stored in the mobile phone as information existing in short messages, emails or calendar prompts, what would the second party usually do? The possible solutions are listed as follows:
(1) the second party hangs the phone up, finds the information from the mobile phone, makes use of the transfer function to find the telephone number of the first party and transfer the information to the first party; alternatively,
(2) the second party does not hang the phone up, but instead moves the mobile phone away from the ear to the front of the face, finds out the information to be sent, sees a portion thereof, moves the mobile phone back to the ear to read out the information to the first party, and then moves the mobile phone again to the front of the face to see another portion of the information, then moves the mobile phone back again to the ear to read out the information to the first party . . . .

This is a very boring procedure and wastes a piece of very important information, i.e., the mobile phone of the second party is aware as with whom the calling is being made. It is redundant in solution (1) to find the telephone number again, while solution (2) is not only inconvenient but also impossible to share other information than characters.

Taking for another example when I am chitchatting with another people in such enthusiasm that I talk about a certain photograph I took several days before in a certain place, and I want to send him the photograph without our hanging the phones up, so that I send him a multimedia message and then continue the chat. This would require that we share any information and any file in the mobile phones of each other during the process of calling.

It is so far impossible for currently available mobile phones and other mobile communication terminals to solve the foregoing problems in a desirable manner.

### SUMMARY OF THE INVENTION

The present invention is directed to provide sharing and transmitting of information (files) between calling parties during the process of calling.

Specifically speaking, the “information sharing” function is activated during the process of calling in the present invention, so that upon selection of the “information sharing” function the mobile communication terminal of the called party is automatically taken as destination and the information to be shared is transmitted to the called party by short message, multimedia, and email transmission function modules etc. Alternatively, during calling such transmission functions as the short message, multimedia message and email are automatically associated with the “information sharing” function as an option by default, so that upon selection by a user of the information to be shared and one of the short message, multimedia message and email transmission functions, the information to be shared is directly transmitted to the called party via the “information sharing” function by default.

The present invention brings about a novel user-experience, i.e., information can be shared and files can be transmitted conveniently between parties without the calling being broken off.

The present invention is suitable for application in any kind of information shared during the process of calling, including a phonebook, a short message, a multimedia message, an electronic mail, a calendar prompt, an audio file, a video file, a photograph, a bookmark, a radio channel and so on.

In order to achieve the aforementioned objective of the present invention, there is provided according to the first aspect of the present invention a method of sharing information between two calling parties in a wireless communication system, wherein the first calling party uses information sharing function activated in a first mobile communication terminal of the first calling party during calling, and automatically takes a second mobile communication terminal of the second calling party as the called party as destination to transmit information in the first mobile communication terminal for sharing.

There is provided according to the second aspect of the present invention a mobile communication terminal enabling information sharing between a first calling party using the mobile communication terminal and a second calling party using another mobile communication terminal during calling, wherein mobile communication terminal comprises an information sharing part, which is activated during calling to enable transmission of information in the mobile communication terminal for sharing with the another mobile communication terminal as destination.

There is provided according to the third aspect of the present invention a computer program, when executed, to make mobile communications terminals to perform a method of sharing information between two calling parties in a wireless communication system, wherein the first calling party uses information sharing function activated in a first mobile communication terminal of the first calling party during calling, and automatically takes a second mobile communication terminal of the second calling party as the called party as destination to transmit information in the first mobile communication terminal for sharing.

There is provided according to the fourth aspect of the present invention a computer readable storage medium having a computer program thereon, the computer program, when executed, making mobile communications terminals to perform a method of sharing information between two calling parties in a wireless communication system, wherein the first calling party uses information sharing function activated in a first mobile communication terminal of the first calling party during calling, and automatically takes a second mobile communication terminal of the second calling party as the called party as destination to transmit information in the first mobile communication terminal for sharing.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### DESCRIPTION OF ACCOMPANYING DRAWINGS

The drawings as included herein constitute a portion of the Description to exemplarily illustrate the embodiments of the present invention, and enunciate the principles of the present invention together with the texts. In the drawings,

FIG. 1 is an illustrative display screen showing the use of the mobile communication terminal according to the first embodiment of the present invention;

FIG. 2 is an illustrative display screen showing the use of the mobile communication terminal according to the second embodiment of the present invention;

FIG. 3 is a flowchart exemplarily showing the process of execution of the first embodiment according to the present invention;

FIG. 4 is a flowchart exemplarily showing the process of execution of the second embodiment according to the present invention; and

FIG. 5 is a schematic system diagram of circuitry and associated parts of the mobile phone for carrying out operation thereof in a manner described below.

### DESCRIPTION OF EMBODIMENTS

In the present application, the embodiments of the present invention are described mainly in terms of communication terminals in the form of mobile phones (also referred to as handsets). However, it should be understood that the present invention is not restricted to the mobile phones, as communication terminals of any types can be applied as long as they are adapted to communications.

The present invention is described below in conjunction with a display screen that makes use of the mobile communication terminal according to the present invention with reference to a flowchart showing the process of the present invention.

As should be particularly pointed out, the display screen as shown is merely exemplary in nature, and displayed on the display screen are only those contents having direct relevance to the present invention, while other publicly known options (such as menu or button) are not displayed so as to highlight the inventive essentials of the present invention. In addition, for the sake of differentiation, gray color is employed on the display screen to indicate options that are “selected”, while white color is employed thereon to indicate those that are “not selected”. But an actual display screen is not restricted thereto, as various colors and brightness can be used to indicate options that are “selected” or “not selected”. Moreover, the arrangement modes of the various options in the drawings are also merely exemplary in nature to indicate correlations between each of the options, whereas it is not intended to illustrate that the positional relationships of the options in actual display should be strictly as shown in the drawings.

Therefore, upon reading of the Description with reference to the drawings, a person skilled in the art should understand the substance in principle of the present invention, and should not misunderstand to the effect that an actual display screen incorporating the mobile communication terminal according to the present invention should be exactly the same as the one exemplarily shown in the drawings.

The general concept of the present invention rests in that, when a first and a second two persons use mobile communication terminals (such as mobile phones) to communicate to each other for example, one “information sharing” function module in each of their mobile communication terminals is activated, so that, when for instance the first person intends to transmit information (such as a phonebook, a short message, a multimedia message, an electronic mail, a calendar prompt, an audio file, a video file, a photograph, a bookmark, a radio channel and so on) stored in the mobile communication terminal of the first person to the second person upon request from the second person or out of the intent of the first person himself, the information can be conveniently transmitted to the second person by directly taking the telephone number of the second person as destination without having to break off calling and the annoyance of inputting the telephone number of the second person again being dispensed with. Of course, this holds true also in the case of the second person transmitting information to the first person. This achieves information sharing in the convenient process of calling.

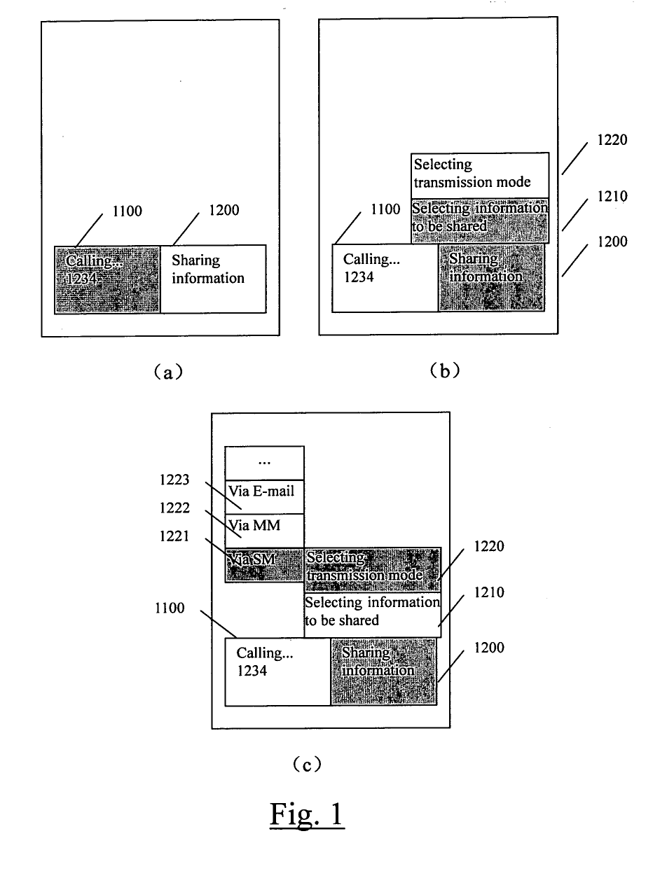

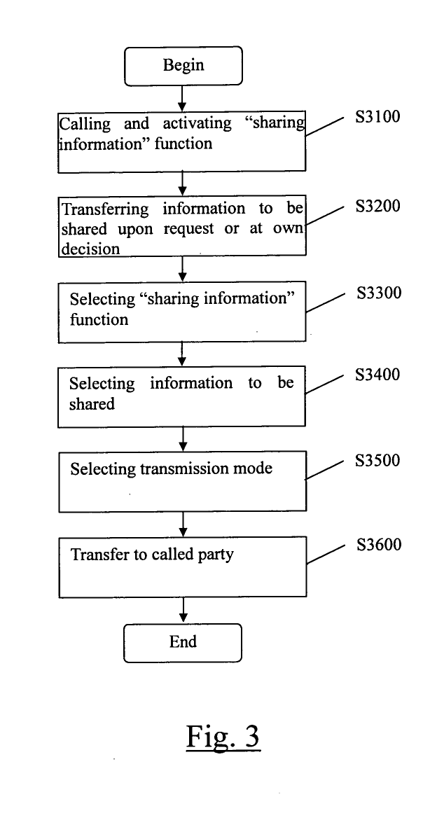

The first embodiment of the present invention is described below with reference to FIGS. 1 and 3.

On start of calling between the first and the second persons, the “information sharing” function module is activated in each of their mobile communication terminals (Step S3100). By now, for instance, option 1100 of “calling” and option 1200 of “information sharing” are displayed in association with each other on the display screen of the mobile communication terminal of the first person, as shown in FIG. 1 (a). The option 1100 of “calling” indicates calling is being made between the first person and the second person, while the telephone number of the second person (“1234” as shown in FIG. 1) is also indicated. What is easily conceivable is the fact that, if the telephone number of the second person is stored in the phonebook of the mobile communication terminal of the first person, an identification information, such as the name of the second person, other than the telephone number, can be displayed in the option 1100 of “calling”. In such a circumstance, the option 1100 of “calling” is in the state of being “selected”.

Subsequently, if the second person asks the first person or the first person decides himself to transmit the information in the mobile communication terminal of the first person, such as a phonebook, a short message, a multimedia message, an electronic mail, a calendar prompt, an audio file, a video file, a photograph, a bookmark, a radio channel and so on, to the second person (Step 3200), the first person uses for instance such function keys as the guide key on his mobile communication terminal to make selections to switch the option 1200 of “information sharing” into the state of being “selected” (Step S3300). By this time option 1210 of “selecting information to be shared” and option 1220 of “selecting transmission mode” are shown in cascade in the “information sharing” option, as shown in FIG. 1(b). Under this state, the option 1210 of “selecting information to be shared” is in the state of being “selected”.

Next, by clicking the option 1210 of “selecting information to be shared”, the first person can switch into the more specific “function list” of the mobile communication terminal, so as to further select the information to be transmitted (Step S3400). This selection process is the same as the conventional process of selecting information from a mobile communication terminal, and therefore no detailed description is made here with regard thereto.

After selection and confirmation of the information to be transmitted, the display screen returns to the state as shown in FIG. 1 (b). By this time, upon selection by the first person of the option 1220 of “selecting transmission mode”, plural transmission function options such as “via short message” 1221, “via multimedia message” 1222, and “via email” 1223 are shown in cascade, as shown in FIG. 1 (c). Under this state, the first person may select different transmission modes according to demand (Step S3500). After selection and confirmation of the transmission mode, the mobile communication terminal of the first person employs the selected transmission mode to automatically transmit the information to be shared as selected to the mobile communication terminal of the second person (Step S3600), while the process for the first person to input the telephone number of the second person again or to select the second person as the recipient from the phonebook is dispensed with, and there is no need to break off calling.

The above description is directed to the circumstance where the “information sharing” function is set as an independent module. But this is not the only mode. For instance, as can be also conceived during calling, the “information sharing” function is activated and associated with such transmission functions as short messages, multimedia messages and emails, etc., so that the user can transmit information according to conventional operation modes, i.e., conventional function, option and/or operation keys are used when necessary to firstly select the information to be transmitted, and then select the transmission mode. Users are more familiar with such operation modes.

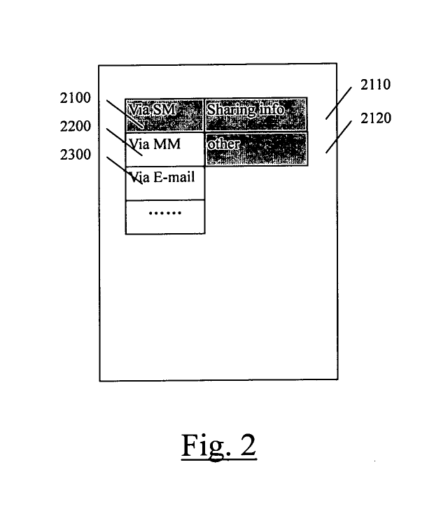

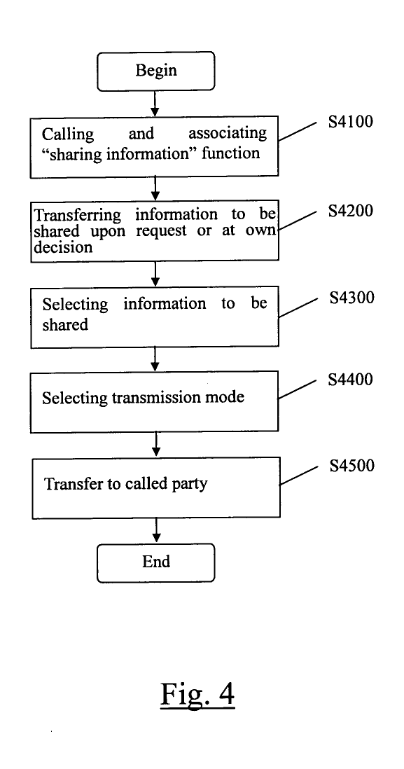

The second embodiment of the present invention is described with reference to FIGS. 2 and 4.

Firstly, on start of communication between the first person and the second person, the “information sharing” function module in each of their mobile communication terminals is associated with the short message, multimedia message and email transmission function modules; in other words, the “information sharing” function is set by default as options of the short message, multimedia message and email transmission function modules (Step S4100). This process brings no change in the current calling screen of the mobile communication terminal.

Subsequently, upon request from the second person or on the decision of the first person himself, the first person transmits the information in the mobile communication terminal, such as a phonebook, a short message, a multimedia message, an electronic mail, a calendar prompt, an audio file, a video file, a photograph, a bookmark, a radio channel and so on, to the second person (Step S4200). The first person switches operation interfaces in a conventional mode to select the information to be shared (Step S4300). As should be aware to a person skilled in the art, Step S4300 is a conventional operation, and therefore no detailed description is made thereto.

Consequently, after selection of the information to be shared, the first person selects the transmission mode also in a conventional operation mode (Step S4400). As shown by the display screen of FIG. 2, when one transmission mode is selected, “via short message” 2100, for instance, from amongst plural modes such as “via short message” 2100, “via multimedia message” 2200 and “via email” 2300, option 2110 of “information sharing” as the option by default and option 2120 of “others” are further shown in cascade. If the option 2110 of “information sharing” is selected, the mobile communication terminal of the first person makes use of the selected transmission mode to automatically transmit the information to be shared as selected to the mobile communication terminal of the second person (Step S4500). If the first person wants to transmit information to other persons, the option 2120 of “others” is selected, and a recipient is added by such conventional modes as inputting the telephone number or selecting a certain person from the phonebook.

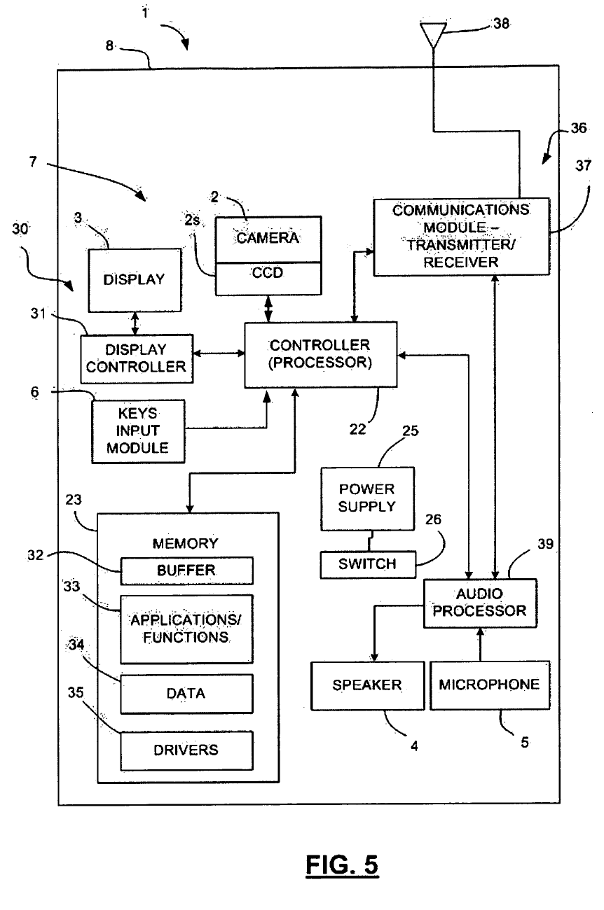

Briefly turning to FIG. 5, a schematic block diagram of the system of a mobile communication terminal 1, e.g., that may embody the features described above with respect to FIGS. 1-4, and of the operating circuitry 7 of the mobile communication terminal 1 is illustrated. The illustration is exemplary; other types of circuitry may be employed in addition to or instead of the operating circuitry 7 to carry out the functions described above of the mobile communication terminal 1. The operating circuitry 7 includes a controller 22 (sometimes referred to as a processor or as an operational control and may include a microprocessor or other processor device and/or logic device) that receives inputs and controls the various parts and operation of the operating circuitry. An input module 30 provides inputs to the controller 22. The input module 30 includes the camera 2, a display controller 31, and a keys input module 6.

The camera 2 may include a lens, shutter, image sensor 2s, e.g., a digital image sensor, such as, for example, a CCD (charge coupled device), a CMOS device, or another image sensor. Images that are sensed by the image sensor may be provided to the controller 22 for use in the manner described herein. The display controller 31 responds to inputs from a touch sensitive display 3 or from another type of display that is capable of providing inputs to the controller. Thus, for example, touching of a stylus or a finger to a part of a touch sensitive display, e.g., to select a song in a displayed list of songs, to select a contact in a displayed list of contacts, to select an icon or function in a GUI shown on the display may provide an input to the controller in conventional manner. The display controller 31 also may receive inputs from the controller 22 to cause images, icons, information, keypad 6, etc., to be shown on the display 3. The keys input module 6, for example, may be the physical keys or images of keys, and/or may be signal conditioning, decoding or other appropriate circuitry to provide to the controller 22 information indicating the operating of one or more keys in conventional manner.

The memory 23 is coupled to the controller 22. The memory may be a solid state memory, e.g., read only memory (ROM), random access memory (RAM), SIM card, etc., or memory that maintains information even when power is off and that can be selectively erased and provided with more data, an example of which sometimes is referred to as an EPROM or the like. The memory may be some other type device. The memory 23 includes a buffer memory 32 (sometimes referred to herein as buffer). The memory 23 may include an applications or functions storing section or function 33 to store applications programs and functions programs or routines for carrying out operation of the mobile communication terminal 1 via the controller 22. The memory 23 also may include a data storage section or function 34 to store data, e.g., contacts, numerical data, pictures, and/or virtually any other data for use by the mobile communication terminal 1. A drivers section 35 of the memory 34 may include various drivers for the mobile communication terminal 1, for communication functions and/or for carrying out other functions of the mobile communication terminal. The memory 23 may be used to save photographs from the camera 2. The portions of the memory 23 may be separate memory devices or may be a respective address sections of one or more memory devices.

The mobile communication terminal 1 includes a telecommunications portion 36, including a communications module—transmitter/receiver 37 that receives incoming signals and transmits outgoing signals via antenna 38. The communications module—transmitter/receiver 37 is coupled to the controller 22 to provide inputs to and to receive output signals, as may be the case in conventional mobile phones. The communications module—transmitter/receiver 37 also is coupled to the speaker 4 and microphone 5 via an audio processor 39 to provide audio output via the speaker and to receive audio input from the microphone for usual telecommunications functions. The speaker 4 and microphone 5 enable a user to listen and to speak via the mobile communication terminal 1. Audio data may be passed to the audio processor 39 from the memory 23 via the controller 22 for playback to the user. The audio data may include, for example, audio data from an audio file stored in the memory 23 and retrieved by the controller 22. The audio processor 39 may include any appropriate buffers, decoders, amplifiers and the like.

The mobile communication terminal 1 also includes a power supply 25 that may be coupled to provide electrical power to the operational circuitry 7 upon closing of the on/off switch 26.

For telecommunication functions and/or for various other applications and/or functions as may be selected from a GUI, the mobile communication terminal 1 may operate in a conventional way. For example, the mobile communication terminal may be used to make and to receive telephone calls, to play back songs, pictures, videos, movies, etc., to take and to store photographs or video, to prepare, to save, to maintain, and to display documents and databases such as a contacts or other database, to browse the Internet, to maintain a calendar, etc.

The above description is directed to the use of such function keys as the guide key to perform selection operations, but it is also possible in the case where the mobile communication terminal is equipped with a touch screen to perform selection by directly touching the screen.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts or otherwise described herein may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams or otherwise described herein, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of sharing information between two calling parties in a wireless communication system, characterized in that the first calling party uses information sharing function activated in a first mobile communication terminal of the first calling party during calling, and automatically takes a second mobile communication terminal of the second calling party as the called party as destination to transmit information in the first mobile communication terminal for sharing.

2. The method according to claim 1, characterized in that the information sharing function is presented after activation on a call display screen of the first mobile communication terminal in the form of a button in association with identification information of the second calling party.

3. The method according to claim 2, characterized in that, in response to a request from the second calling party or in accordance with an intent of the first calling party itself, the first calling party clicks the button indicative of the information sharing function as presented on the call display screen of the first mobile communication terminal, and subsequently adds the information for sharing to transmit the information to the second mobile communication terminal.

4. The method according to claim 3, characterized in that, after addition of the information for sharing, the information sharing function invokes any one transmission function selected from a transmission function set including short message transmission function, multimedia message transmission function and electronic mail transmission function to transmit the information.

5. The method according to claim 2, characterized in that the identification information of the second calling party is a telephone number or a name thereof.

6. The method according to claim 1, characterized in that after activation the information sharing function is associated with each transmission function in the transmission function set including short message transmission function, multimedia message transmission function and electronic mail transmission function of the first mobile communication terminal, so that the information sharing function is revoked by default during revocation of each transmission function.

7. The method according to claim 6, characterized in that, in response to a request from the second calling party or in accordance with an intent of the first calling party itself, the first calling party selects the information for sharing without interrupting calling, and subsequently revokes any one transmission function from the transmission function set to transmit the information to the second mobile communication terminal through the information sharing function by default.

8. The method according to any one of the foregoing claims, characterized in that the information for sharing is any information selected from an information set including a phonebook, a short message, a multimedia message, an electronic mail, a calendar prompt, an audio file, a video file, a photograph, a bookmark and a radio channel.

9. A mobile communication terminal enabling information sharing between a first calling party using the mobile communication terminal and a second calling party using another mobile communication terminal during calling, characterized in that the mobile communication terminal comprises:
an information sharing part, which is activated during calling to enable transmission of information in the mobile communication terminal for sharing with the another mobile communication terminal as destination.

10. The mobile communication terminal according to claim 9, characterized in that the information sharing part is presented after activation on a call display screen of the mobile communication terminal in the form of a button in association with identification information of the second calling party.

11. The mobile communication terminal according to claim 10, characterized in that the information sharing part includes an information adding part,
wherein, after the first calling party clicks the button indicative of the information sharing part in response to a request from the second calling party or in accordance with an intent of the first calling party itself, the information adding part is activated to add the information for sharing.

12. The mobile communication terminal according to claim 11, characterized in that the information sharing part further includes an information transmitting part, which transmits the information for sharing by means of ant one transmission function module selected from a transmission function module set including a short message transmission function module, a multimedia message transmission function module and an electronic mail transmission function module.

13. The mobile communication terminal according to claim 10, characterized in that the identification information of the second calling party is a telephone number or a name thereof.

14. The mobile communication terminal according to claim 9, characterized in that upon activation the information sharing part is associated with each transmission function module in the transmission function module set including a short message transmission function module, a multimedia message transmission function module and an electronic mail transmission function module, so that the information sharing part is revoked by default during revocation of each transmission function module.

15. The mobile communication terminal according to claim 14, characterized in that, in response to a request from the second calling party or in accordance with an intent of the first calling party itself, the first calling party selects the information for sharing without interrupting calling, and subsequently revokes a random transmission function module from the transmission function module set to transmit the information to the another mobile communication terminal through the information sharing part by default.

16. The mobile communication terminal according to any one of claims 9 to 15, characterized in that the information for sharing is any information selected from an information set including a phonebook, a short message, a multimedia message, an electronic mail, a calendar prompt, an audio file, a video file, a photograph, a bookmark and a radio channel.
